(19) United States
(12) Patent Application Publication
(10) Pub. No.: US 2007/0220697 A1
(43) Pub. Date: Sep. 27, 2007

(54) WIPER FOR AN AUTOMOBILE REAR-VIEW MIRROR

(76) Inventor: Chiang-Fen Lin, Yongkang City (TW)

Correspondence Address: CHIANG-FEN LIN, P.O. BOX 90, Tainan City, 70499, TW

(21) Appl. No.: 11/389,227

(22) Filed: Mar. 27, 2006

(51) Int. Cl. B60S 1/56; B60S 1/60; B60S 1/18; B60S 1/44

(52) U.S. Cl. 15/250.003; 15/250.29

(57) ABSTRACT

A wiper for an automobile rear-view mirror includes a base and a transmission motor installed in the base and having a worm engaged with a transmission gear, which is eccentrically fixed with a pivot connected with a connecting rod. The connecting rod has the other end connected with a driving rod provided with a fixing shaft and having the other end connected with a first slide block fitted on one end of a shaft that has the other end fitted with a second slide block. The two slide blocks have their front sides pivotally connected with two push rods coupled by a pivot and having their rear side positioned on a positioning plate having a wiping bar at the inner side. The wiping bar can be moved up and down, wiping out water on the mirror surface, enabling a driver to clearly see the images reflected in the rear-view mirror.

### BACKGROUND OF THE INVENTION

1. Field of the Invention

This invention relates to a wiper for an automobile rear-view mirror, particularly to one able to wipe out water drops remaining on the surface of a rear-view mirror to enable a driver to clearly see the images reflected in the rear-view mirrors.

2. Description of the Prior Art

As commonly known, a driver must watch the moving conditions of the vehicles coming from behind on the left and the right rear-view mirror before making a turn, overtaking a car, changing lanes or parking. However, in raining days, rainwater will remain on the rear-view mirrors of an automobile, making the rear-view mirrors unable to reflect images clearly. In this case, the driver of an automobile, especially the driver of a large-sized one, cannot clearly see the conditions of the vehicles coming from behind, thus likely to cause an accident.

### SUMMARY OF THE INVENTION

The objective of the invention is to offer a wiper for an automobile rear-view mirror, able to surely wipe out water drops remaining on the surface of a rear-view mirror to enable a driver to clearly see the images reflected in the rear-view mirrors.

The wiper for an automobile rear-view mirror in the present invention includes a base, and a transmission motor installed at the rear side of the base. The transmission motor is provided with a worm engaged with a transmission gear, which is eccentrically provided with a pivot connected with one end of a connecting rod. The connecting rod has the other end pivotally connected with a driving rod disposed thereon with a fixing shaft and having the other end pivotally connected with a first slide block fitted on one end of an elongate shaft that has the other end correspondingly fitted thereon with a second slide block. The two slide blocks have their front side respectively and pivotally connected with one end of a push rod, with the two push rods intersecting each other and having their intersecting spot pivotally connected by a pivot. Each push rod has the rear side positioned on a positioning plate provided with a wiping bar in the interior.

### BRIEF DESCRIPTION OF DRAWINGS

This invention will be better understood by referring to the accompanying drawings, wherein:

FIG. 1 is a front perspective view of a wiper for an automobile rear-view mirror in the present invention;

FIG. 2 is a rear perspective view of the wiper for an automobile rear-view mirror in the present invention;

FIG. 3 is a cross-sectional view of a wiping bar in the present invention;

FIG. 4 is a front view of the wiping bars in a reciprocating wiping condition in the present invention;

FIG. 5 is a rear cross-sectional view of two slide blocks reciprocating in the present invention; and

FIG. 6 is a side cross-sectional view of the wiper in the present invention.

### DETAILED DESCRIPTION OF THE PREFERRED EMBODIMENT

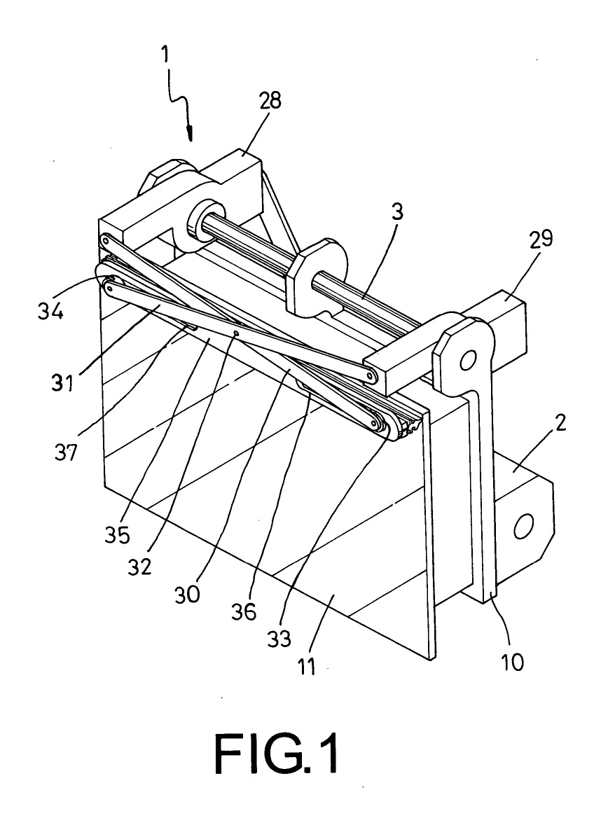

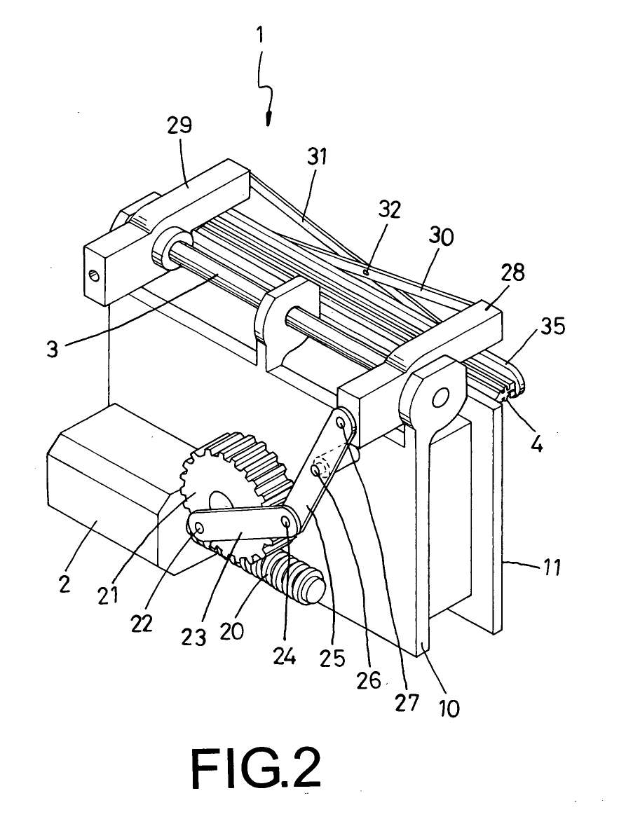

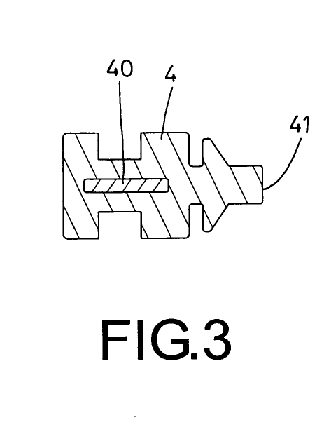

A preferred embodiment of a wiper 1 for an automobile rear-view mirror of a vehicle, as shown in FIGS. 1 and 2, includes a base 10, and a transmission motor 2 installed at the rear side of the base 10. The transmission motor 2 is provided with a worm 20 engaged with a transmission gear 21, which is eccentrically fixed with a pivot connected with one end of a connecting rod 23 that has the other end pivotally connected with a driving rod 25 by a pivot 24. The driving rod 25 has its intermediate spot disposed with a fixing shaft 26 and has the other end pivotally connected with a first slide block 28 by a pivot 27. The first slide block 28 is connected movably on an end of an elongate shaft 3 that has the other end combined with a second slide block 29 movable. The two (the first and the second) slide blocks 28, 29 have their front side respectively and pivotally connected with one end of two push rods 30, 31, which are intersected with each other and have their intersecting spot pivotally coupled by a pivot 32. The two push rods 30, 31 respectively have the other end assembled with a roller 33, 34 respectively positioned in two slide grooves 36, 37 of a positioning plate 35 that is provided with a wiping bar 4 at an inner side. The wiping bar 4 is made of a soft material, having an elastic member 40 disposed lengthwise in the interior, as shown in FIG. 3. The wiping side 41 of the wiping bar 4 contacts closely with the surface 11 of the rear-view mirror 1.

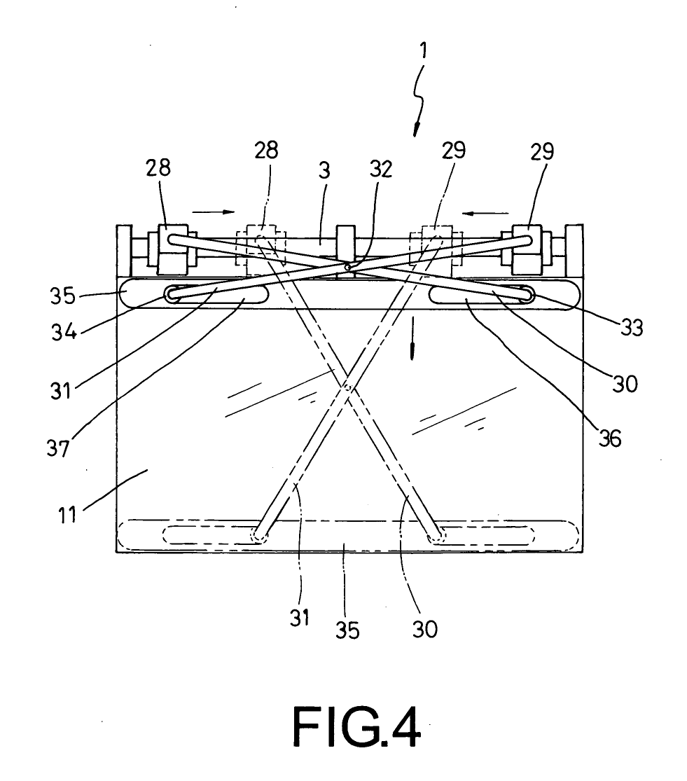

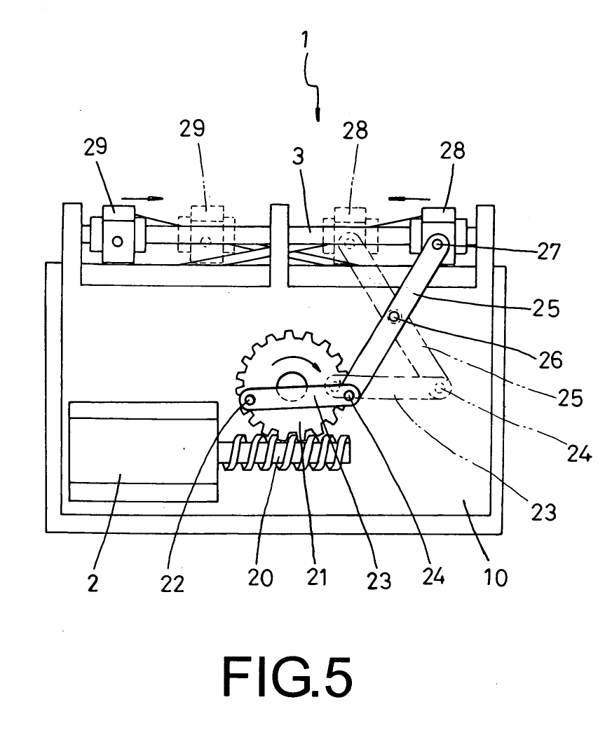

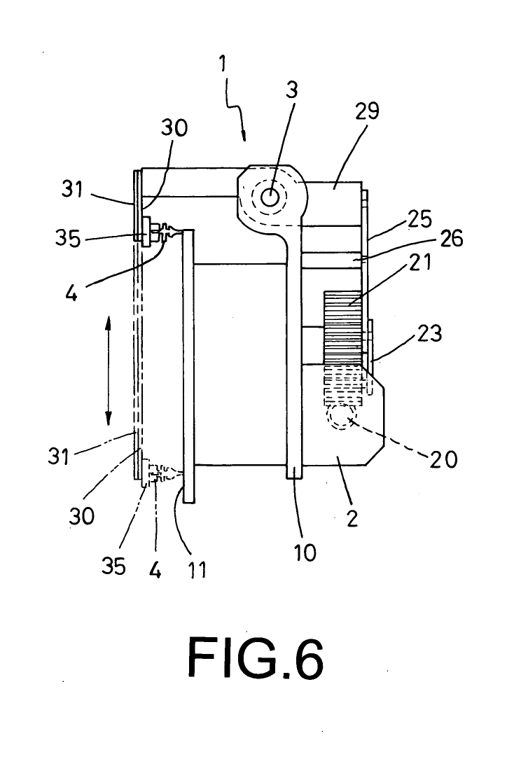

In using, referring to FIGS. 1-6, when it is raining and water drops remain on the surface 11 of the rear-view mirror 1, the transmission motor 2 on the base 10 is to be started to operate to drive the worm 20 to rotate together with the transmission gear 21. Simultaneously, the first end of the connecting rod 23, which is pivotally connected with the transmission gear 21 and has the rotating shaft of the transmission gear 21 acting as a pivot, is actuated to rotate. The driving rod 25, which has a first end pivotally connected with the second end of the connecting rod 23, will be shifted with the fixing shaft 26 serving as a pivot. Meanwhile, a second end of the driving rod 25 is shifted to push the first slide block 28 to shift inward along the shaft 3 and actuate the first push rod 30 pivotally connected to the front end of the first slide block 28 to move inward. At this time, by the function of the pivot 32, the other end of the push rod 30 is moved downward and the roller 33 connected to the other end of the first push rod 30 is actuated to slide in the first slide groove 36 of positioning plate 35 and push the positioning plate 35 to move downward, as shown in FIGS. 4 and 6. Synchronously, the second push rod 31 pivotally connected with the first push rod 30 will relatively be actuated to shift in the second slide groove 37 of the positioning plate 35, and the second slide block 29 connected with second the push rod 31 will be actuated to move inward along the shaft 3, as shown in FIGS. 4 and 5. When the two slide blocks 28, 29 are relatively moved inward, the included angle between the two push rods 30, 31 will become smaller, and the positioning plate 35 together with the wiping bar 4 will be moved downward. On the contrary, when the two slide blocks 28, 29 are relatively moved outward, the included angle between the two push rods 30, 31 will become larger, and the positioning plate 35 together with the wiping bar 4 will be moved upward. Thus, by relative displacement of the two slide blocks 28, 29, the two push rods 30, 31 can be actuated to shift relatively and move the wiping bar 4 up and down on the mirror surface 11 for wiping out the water drops remaining on the mirror surface 11 by its wiping side 41, able to keep the mirror surface 11 clean and enable a driver to clearly see the images reflected in the rear-view mirror 1 for driving with safety.

While the preferred embodiment of the invention has been described above, it will be recognized and understood that various modifications may be made therein and the appended claims are intended to cover all such modifications that may fall within the spirit and scope of the invention.

What is claimed is:

1. A wiper for an automobile rear-view mirror, said wiper comprising a base and a transmission motor installed at a rear side of said base, said transmission motor provided with a worm engaged with a transmission gear, said transmission gear eccentrically provided with a pivot connected with a connecting rod, said connecting rod having the other end pivotally connected with a driving rod having a fixing shaft disposed thereon, said driving rod having the other end pivotally connected with a first slide block fitted on a first end of an elongate shaft, said elongate shaft having a second end fitted with a second slide block, said two slide blocks having their front side respectively and pivotally connected with a first end of two push rods, said two push rods intersecting each other and having their intersecting spot pivotally coupled by a pivot, said two push rods having a second end respectively positioned on a positioning plate, said positioning plate provided with a wiping bar at an inner side.

2. The wiper for an automobile rear-view mirror as claimed in claim 1, wherein said wiping bar is made of a soft material, provided with an elastic member lengthwise in the interior.

3. The wiper for an automobile rear-view mirror as claimed in claim 1, wherein said two push rods have the second end respectively disposed with a roller, and said positioning plate has its opposite ends respectively bored with a slide groove, said roller slidably positioned in said slide groove of said positioning plate.
